(19) United States
(12) Patent Application Publication
(10) Pub. No.: US 2015/0095220 A1
(43) Pub. Date: Apr. 2, 2015

(54) METHOD AND APPARATUS FOR TRANSACTION PROCESSING

(71) Applicant: Huawei Technologies Co., Ltd., Shenzhen (CN)

(72) Inventors: Qi Chen, Shenzhen (CN); Ke Li, Shenzhen (CN); Dingsheng Xue, Shenzhen (CN); Heng Jiang, Shenzhen (CN)

(21) Appl. No.: 14/569,108

(22) Filed: Dec. 12, 2014

Related U.S. Application Data
(63) Continuation of application No. PCT/CN2012/077078, filed on Jun. 18, 2012.

(51) Int. Cl. G06Q 20/38

(52) U.S. Cl. CPC G06Q 20/38
USPC 705/39

(57) ABSTRACT

Embodiments of the present invention disclose a method and an apparatus for transaction processing. The method includes: receiving a transaction request, determining, when it is determined that a real-time account book is undergoing compute-intensive transaction processing, whether an account record of an account on which a transaction is to be performed exists in a temporary account book, and if yes, processing the transaction request based on the account record, and updating the account record in the temporary account book according to a processing result, and if no, reading the account record from the real-time account book, processing the transaction request based on the account record, and recording, in the temporary account book, the updated account record according to a processing result; and updating, after the transaction processing is complete, the real-time account book according to the temporary account book, and deleting the account record after the updating.

### CROSS-REFERENCE TO RELATED APPLICATIONS

This application is a continuation of International Application No. PCT/CN2012/077078, filed on Jun. 18, 2012, which is hereby incorporated by reference in its entirety.

### TECHNICAL FIELD

The present invention relates to the field of charging, and in particular, to a method and an apparatus for transaction processing.

### BACKGROUND

Trial balance is an important job to do at a regular interval for a financial funds accounting system. Its purpose is to check consistency, integrity and correctness for daily variations of funds of all accounts and account voucher (book) records by summary, calculation and comparison. Therefore, trial balance must be guaranteed. It is a requirement to complete day-end processing, and a basic norm for accounting processing of a financial system.

During a process of executing trial balance, if a real-time transaction is performed, it will result in a change of account record data in a real-time account book, easily causing an incorrect trial balance result. Therefore, an existing trial balance process usually needs to lock the real-time account book, so as to suspend real-time transactions.

However, data amount of the real-time account book is enormous, leading to a very time-consuming whole process of trial balance. Suspending real-time transactions during a trial balance process often causes that real-time transactions will not be processed in a long time.

### SUMMARY

Embodiments of the present invention provide a method and an apparatus for transaction processing, which still enable a real-time transaction when a real-time account book cannot be modified during a trial balance process.

According to one aspect, an embodiment of the present invention provides a transaction processing method, where the method includes: receiving a transaction request, determining, when it is determined that a real-time account book is undergoing compute-intensive transaction processing, whether an account record of an account on which a transaction is to be performed exists in a temporary account book, and if yes, processing the transaction request based on the account record of the account on which the transaction is to be performed in the temporary account book, and updating the account record of the account on which the transaction is to be performed in the temporary account book according to a processing result, and if no, reading the account record of the account on which the transaction is to be performed from the real-time account book, processing the transaction request based on the account record of the account on which the transaction is to be performed, and recording, in the temporary account book, the account record of the account on which the transaction is to be performed that is updated according to a processing result; and updating, after the compute-intensive transaction processing is complete, the real-time account book according to the temporary account book, and deleting the account record from the temporary account book after the updating.

According to another aspect, an embodiment of the present invention provides a transaction processing apparatus, where the apparatus includes: a transaction processing module, configured to receive a transaction request, determine, when it is determined that a real-time account book is undergoing compute-intensive transaction processing, whether an account record of an account on which a transaction is to be performed exists in a temporary account book, and if yes, process the transaction request based on the account record of the account on which the transaction is to be performed in the temporary account book, and update the account record of the account on which the transaction is to be performed in the temporary account book according to a processing result, and if no, read the account record of the account on which the transaction is to be performed from the real-time account book, process the transaction request based on the account record of the account on which the transaction is to be performed, and record, in the temporary account book, the account record of the account on which the transaction is to be performed that is updated according to a processing result; and an updating module, configured to update, after the compute-intensive transaction processing is complete, the real-time account book according to the temporary account book, and delete the account record from the temporary account book after the updating.

Based on the foregoing technical solution, by using the method and apparatus for transaction processing provided by the embodiments of the present invention, when a real-time account book is undergoing compute-intensive transaction processing, a transaction request is processed based on a temporary account book, and, after the compute-intensive transaction processing is complete, the real-time account book is updated according to the temporary account book, so as to implement a purpose of a real-time transaction when the real-time account book cannot be modified during a process of compute-intensive transaction processing like a trial balance process.

### BRIEF DESCRIPTION OF THE DRAWINGS

To illustrate the technical solutions in the embodiments of the present invention more clearly, the following briefly introduces the accompanying drawings required for describing the embodiments of the present invention. Apparently, the accompanying drawings in the following description show merely some embodiments of the present invention, and a person of ordinary skill in the art may still derive other drawings from the accompanying drawings without creative efforts.

FIG. 1 is a schematic flowchart of a transaction processing method according to an embodiment of the present invention;

FIG. 2 is a schematic flowchart of a transaction processing method according to another embodiment of the present invention;

FIG. 3 is a schematic block diagram of a transaction processing apparatus according to an embodiment of the present invention; and

FIG. 4 is a schematic block diagram of a transaction processing apparatus according to another embodiment of the present invention.

### DETAILED DESCRIPTION

The following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by persons of ordinary skill in the art based on the embodiments of the present invention without creative efforts shall fall within the protection scope of the present invention.

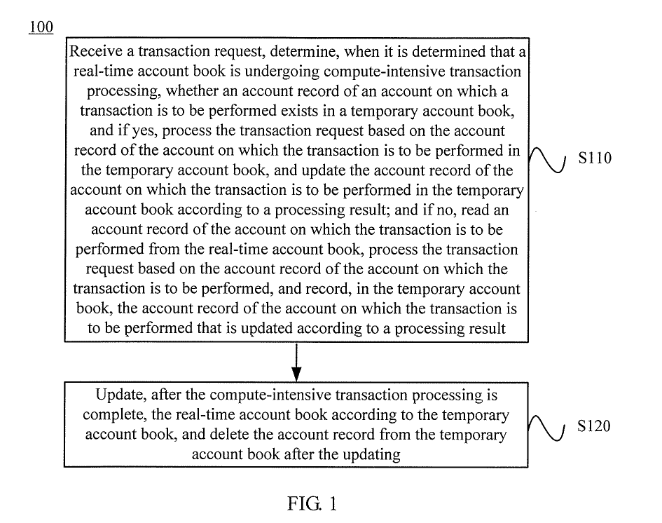

FIG. 1 is a schematic flowchart of a transaction processing method 100 according to an embodiment of the present invention. As shown in FIG. 1, the method 100 includes:

S110. Receive a transaction request, determine, when it is determined that a real-time account book is undergoing compute-intensive transaction processing, whether an account record of an account on which a transaction is to be performed exists in a temporary account book, and if yes, process the transaction request based on the account record of the account on which the transaction is to be performed in the temporary account book, and update the account record of the account on which the transaction is to be performed in the temporary account book according to a processing result, and if no, read the account record of the account on which the transaction is to be performed from the real-time account book, process the transaction request based on the account record of the account on which the transaction is to be performed, and record, in the temporary account book, the account record of the account on which the transaction is to be performed that is updated according to a processing result;

S120. Update, after the compute-intensive transaction processing is complete, the real-time account book according to the temporary account book, and delete the account record from the temporary account book after the updating.

In the embodiment of the present invention, when it is determined that a real-time account book is undergoing compute-intensive transaction processing, a transaction processing apparatus processes a transaction request based on a temporary account book. Specifically, the transaction processing apparatus receives the transaction request, when it is determined that the real-time account book is undergoing compute-intensive transaction processing, first determines whether an account record of an account on which a transaction is to be performed exists in the temporary account book, and if the account record of the account on which the transaction is to be performed exists in the temporary account book, processes the transaction request based on the account record of the account on which the transaction is to be performed in the temporary account book, and updates the account record of the account on which the transaction is to be performed in the temporary account book according to a processing result, and if no account record of the account on which the transaction is to be performed exists in the temporary account book, reads the account record of the account on which the transaction is to be performed from the real-time account book, processes the transaction request based on the account record of the account on which the transaction is to be performed, and records, in the temporary account book, the account record of the account on which the transaction is to be performed that is updated according to a processing result. In other words, during compute-intensive transaction processing, for first transaction processing of an account on which a transaction is to be performed, the account record of the account on which the transaction is to be performed is read from the real-time account book, and the account record of the account on which the transaction is to be performed is recorded in the temporary account book after the transaction processing; for subsequent transaction processing of the account on which the transaction is to be performed, the subsequent transaction processing is performed based on the account record of the account on which the transaction is to be performed in the temporary account book, and the account record of the account on which the transaction is to be performed in the temporary account book is updated after the transaction processing.

Because, during compute-intensive transaction processing, a newest account record of an account on which transaction processing is performed is stored in the temporary account book, after the compute-intensive transaction processing is complete, the account record needs to be updated into the real-time account book. Therefore, in the embodiment of the present invention, the transaction processing apparatus updates, after the compute-intensive transaction processing is complete, the real-time account book according to the temporary account book, and deletes the account record from the temporary account book after the updating.

In this way, by using the transaction processing method provided by the embodiment of the present invention, when a real-time account book is undergoing compute-intensive transaction processing, a transaction request is processed based on a temporary account book, and, after the compute-intensive transaction processing is complete, the real-time account book is updated according to the temporary account book, so as to implement a purpose of a real-time transaction when the real-time account book cannot be modified during a process of compute-intensive transaction processing like a trial balance process. In addition, because the account record that needs to be updated is only the account record of the transaction request received during the process of compute-intensive transaction processing and associated with the account record, compared with a method where all account records of a real-time account book need to be updated, the amount of calculation for the updating operation in the technical solution provided by the embodiment of the present invention is smaller.

It should be understood that the embodiment of the present invention may be applied in a scenario where various compute-intensive transactions conflict with a real-time transaction. For example, the technical solution provided by the embodiment of the present invention may be applied in all scenarios where compute-intensive transactions, like trial balance, disposition of funds in an accounting system, and financial analysis in an enterprise resource planning (Enterprise Resource Planning, ERP for short) system, conflict with a real-time transaction, which means that the foregoing compute-intensive transaction may be a trial balance, a disposition of funds in an accounting system, or a financial analysis in an ERP system.

In the embodiment of the present invention, optionally, S120 specifically includes:

A1. When the temporary account book is not empty, read a predetermined quantity of account records from the temporary account book;

A2. For each of the read account records, update a corresponding account record in the real-time account book according to each of the account records, and delete each of the account records after the updating;

A3. After updating the predetermined quantity of the account records, return to step A1.

Because there may be multiple accounts undergoing transaction processing during the compute-intensive transaction processing, there may be multiple corresponding account records in the temporary account book. If the account records are copied to the real-time account book at the same time, the copy time will be long, and no transaction can be performed on an account during a copy process. Therefore, in the embodiment of the present invention, optionally, the transaction processing apparatus updates the account records in the temporary account book to the real-time account book in batches. That is, when the temporary account book is not empty, a predetermined quantity of account records are read from the temporary account book each time; and, for each of the read account records, a corresponding account record in the real-time account book is updated according to each of the account records, and each of the account records is deleted after the updating. When the temporary account book is empty, the updating is complete. The predetermined quantity to be updated in each batch may be adjusted according to the number of concurrent transactions. For example, if there are many concurrent transactions, the number of account records to be updated in each batch may be decreased, so as to reduce a blocking rate of concurrent transactions; and, if there are a few concurrent transactions, the number of account records to be updated in each batch may be increased, so as to reduce the total number of batches. It should be understood that the minimal predetermined quantity to be updated in each batch may be 1, and the maximum may be the number of all account records in the temporary book. That is, the account records in the temporary book may be updated to the real-time account book one by one, or all account records may be updated in one batch.

During a period of the updating process after the compute-intensive transaction processing is complete, because a batch-based updating manner is adopted, where a predetermined quantity of account records are updated each time, transactions can be performed on other accounts that are not being updated during this period. Optionally, a transaction during this period can be implemented by using the following manner:

determining, when it is determined that the real-time account book is in a being updated state after the compute-intensive transaction processing is complete, whether an account record of an account on which a transaction is to be performed exists in a temporary account book, and if yes, processing the transaction request based on the account record of the account on which the transaction is to be performed in the temporary account book, and updating the account record of the account on which the transaction is to be performed in the temporary account book according to the processing result, and if no, reading the account record of the account on which the transaction is to be performed from the real-time account book, processing the transaction request based on the account record of the account on which the transaction is to be performed, and recording, in the temporary account book, the account record of the account on which the transaction is to be performed that is updated according to the processing result.

Optionally, a transaction during this period may also be implemented by using the following manner:

determining, when it is determined that the real-time account book is in a being updated state after the compute-intensive transaction processing is complete, whether an account record of an account on which a transaction is to be performed exists in a temporary account book, and if yes, processing the transaction request based on the account record of the account on which the transaction is to be performed in the temporary account book, and updating the account record of the account on which the transaction is to be performed in the temporary account book according to the processing result, and if no, processing the transaction request based on the account record of the account on which the transaction is to be performed in the real-time account book, and updating the account record of the account on which the transaction is to be performed in the real-time account book according to the processing result.

Therefore, by using the transaction processing method provided by the embodiment of the present invention, it is not only unnecessary to copy all account records in advance, but also, during a process of an updating process after compute-intensive transaction processing is complete, a blocking rate of concurrent transactions is further reduced by adopting the batch-based updating manner.

In the embodiment of the present invention, optionally, the method 100 further includes:

processing, when it is determined that the real-time account book is not undergoing compute-intensive transaction processing, the transaction request based on the account record of the account on which the transaction is to be performed in the real-time account book, and updating the account record of the account on which the transaction is to be performed in the real-time account book according to a processing result.

When the real-time account book is not undergoing compute-intensive transaction processing, the transaction processing apparatus processes the transaction request based on the real-time account book, which means that a normal transaction processing manner is adopted.

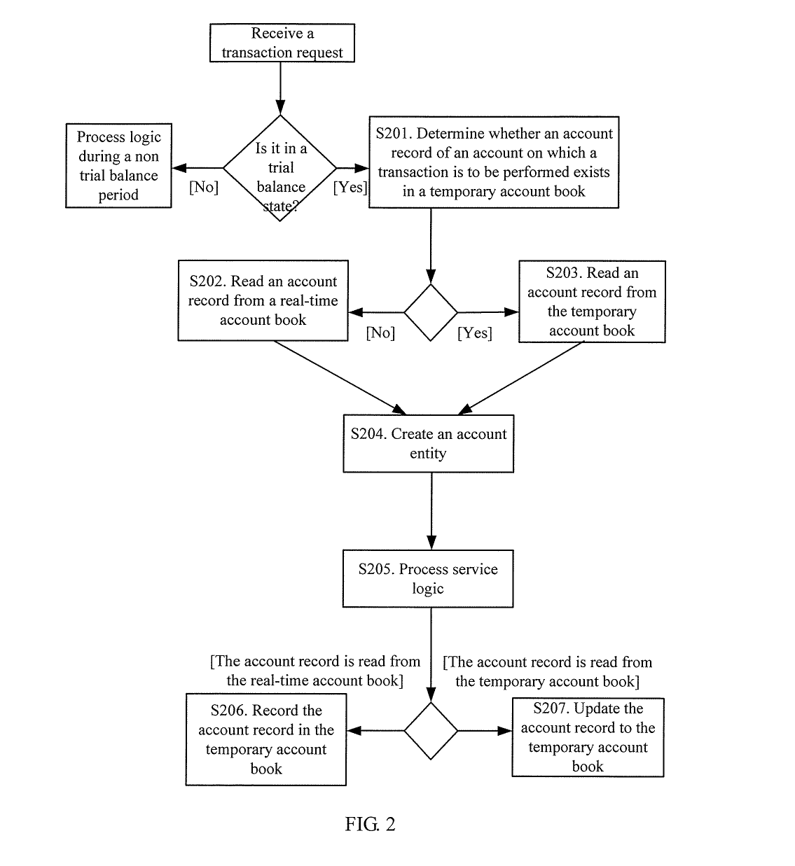

The following describes, with reference to FIG. 2, a transaction processing method provided by an embodiment of the present invention in detail by using a scenario where trial balance processing and a real-time transaction occur concurrently as an example. It should be noted that these examples are merely used to help a person skilled in the art understand some possible implementation manners of the present invention, but not to exhaustively list all implementation manners, so these examples cannot be understood as limitation on the protection scope of the present invention.

During a non trial balance period, a procedure of transaction processing is a conventional procedure in the prior art, which is not further described herein. During a trial balance period, trial balance processing is performed based on a real-time account book, where the real-time account book cannot be modified. During this period, there will be a certain account on which a transaction needs to be performed. For example, at a moment t0, a transaction T0 is performed, intending to add RMB100 to account A; at a moment t1, a transaction T1 is performed, intending to deduct RMB50 from account A, where T0 occurs before T1.

Firstly, the transaction T0 is processed, where a specific procedure is as follows:

S201. Determine whether there is an account record of the account on which the transaction is to be performed in a temporary account book. At the moment t0, the transaction T0 needs to be performed. A transaction processing apparatus determines that the real-time account book is undergoing trial balance processing, so transaction processing on account A needs to be performed based on the temporary account book. The transaction processing apparatus first determines whether an account record of account A exists in the temporary account book. Because it is the first transaction during the trial balance processing, no account record of account A exists in the temporary account book.

S202. Read an account record from the real-time account book. Because no account record of account A exists in the temporary account book, the transaction processing apparatus reads the account record of account A from the real-time account book.

S204. Create an account entity. The read account record of account A is extracted into a memory, and an account entity is created, so as to prepare for the transaction processing.

S205. Process service logic. Specific processing logic of the transaction T0 is completed, that is, RMB100 is added to account A.

S206. Record the account record into the temporary account book. Because the account record of account A is read from the real-time account book, after the transaction processing, the transaction processing apparatus records the account record of the processed account A into the temporary account book.

After processing of the transaction T0 is complete, the trial balance does not end yet. At the moment t1, the transaction T1 is processed, where a specific procedure is as follows:

S201. Determine whether there is an account record of the account on which the transaction is to be performed in the temporary account book. Because it is the second transaction during the trial balance processing, an account record of account A already exists in the temporary account book.

S203. Read the account record from the temporary account book. Because an account record of account A already exists in the temporary account book, the account record of account A is read from the temporary account book.

S204. Create an account entity. The read account record of account A is extracted into a memory, and an account entity is created, so as to prepare for the transaction processing.

S205. Process service logic. Specific processing logic of the transaction T1 is completed, that is, RMB50 is deducted from account A.

S207. Update the account record to the temporary account book. Because the account record of account A is read from the temporary account book, after the transaction processing, the transaction processing apparatus updates the account record of the processed account A to the temporary account book. At this moment, a balance of account A in the temporary account book is a newest balance.

After the trial balance processing is complete, the transaction processing apparatus updates the real-time account book according to the temporary account book, and deletes the account record from the temporary account book after the updating. After the account record of account A in the temporary account book is updated to the real-time account book, a balance of account A in the real-time account book is a newest balance.

In the embodiment of the present invention, trial balance is performed based on a real-time account book. In addition, at the same time of trial balance, a real-time transaction on a sub-account is implemented based on a temporary account book, where suspending the real-time transaction is unnecessary.

Therefore, by using the transaction processing method provided by the embodiment of the present invention, it is unnecessary to copy all account records in advance, and a real-time transaction can still be performed when a real-time account book cannot be modified, thereby reducing a blocking rate of concurrent transactions.

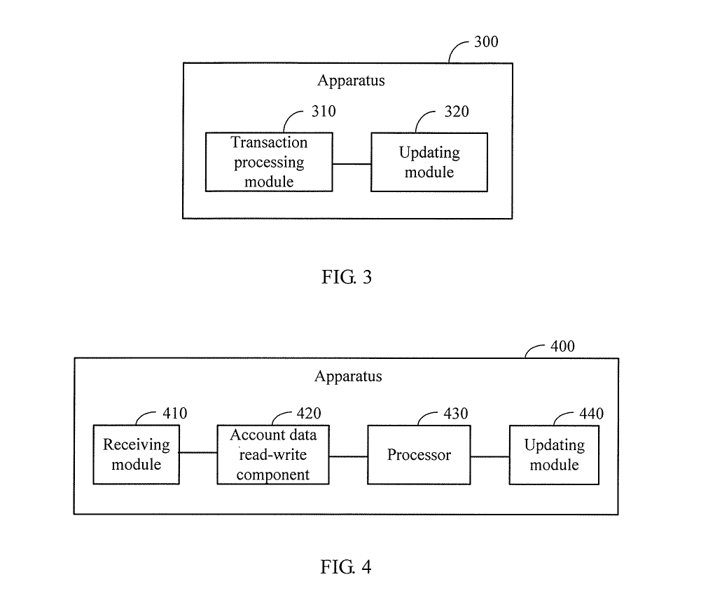

The foregoing describes, with reference to FIG. 1 and FIG. 2, the transaction processing method in detail according to the embodiments of the present invention. In the following, with reference to FIG. 3 and FIG. 4, a transaction processing apparatus is described according to embodiments of the present invention.

FIG. 3 is a schematic block diagram of a transaction processing apparatus 300 according to an embodiment of the present invention. As shown in FIG. 3, the apparatus 300 includes:

a transaction processing module 310, configured to receive a transaction request, determine, when it is determined that a real-time account book is undergoing compute-intensive transaction processing, whether an account record of an account on which a transaction is to be performed exists in a temporary account book, and if yes, process the transaction request based on the account record of the account on which the transaction is to be performed in the temporary account book, and update the account record of the account on which the transaction is to be performed in the temporary account book according to a processing result, and if no, read the account record of the account on which the transaction is to be performed from the real-time account book, process the transaction request based on the account record of the account on which the transaction is to be performed, and record, in the temporary account book, the account record of the account on which the transaction is to be performed that is updated according to a processing result; and

an updating module 320, configured to update, after the compute-intensive transaction processing is complete, the real-time account book according to the temporary account book, and delete the account record from the temporary account book after the updating.

The transaction processing apparatus provided by the embodiment of the present invention processes, when a real-time account book is undergoing compute-intensive transaction processing, a transaction request based on a temporary account book, and updates, after the compute-intensive transaction processing is complete, the real-time account book according to the temporary account book, so as to implement a purpose of a real-time transaction when the real-time account book cannot be modified during a process of compute-intensive transaction processing like a trial balance process. In addition, because the account record that needs to be updated is only the account record of the transaction request received during the process of compute-intensive transaction processing and associated with the account record, compared with a method where all account records of a real-time account book need to be updated, the amount of calculation for the updating operation in the technical solution provided by the embodiment of the present invention is smaller.

In the embodiment of the present invention, optionally, the transaction processing module 310 is further configured to process, when it is determined that the real-time account book is not undergoing compute-intensive transaction processing, the transaction request based on the account record of the account on which the transaction is to be performed in the real-time account book, and update the account record of the account on which the transaction is to be performed in the real-time account book according to a processing result.

In the embodiment of the present invention, optionally, the updating module 320 is specifically configured to read, when the temporary account book is not empty, a predetermined quantity of account records from the temporary account book, update, for each of the read account records, a corresponding account record in the real-time account book according to each of the account records, and delete each of the account records after the updating. It should be understood that, when the temporary account book is not empty, the updating module 320 repeats executing the foregoing operations.

The transaction processing apparatus 300 according to the embodiment of the present invention may correspond to an executing entity of the transaction processing method provided by the embodiments of the present invention, and the foregoing and other operations and/or functions of the modules in the apparatus 300 are respectively intended to implement corresponding procedures of the methods in FIG. 1 and FIG. 2, and, for brevity, details are not repeatedly described herein.

In the apparatus provided by the embodiment of the present invention, it is unnecessary to copy all account records in advance, and a real-time transaction can still be performed when a real-time account book cannot be modified. Therefore, a blocking rate of concurrent transactions can be reduced and, by adopting a batch-based updating manner, the blocking rate of concurrent transactions can be further reduced.

FIG. 4 is a schematic block diagram of a transaction processing apparatus 400 according to another embodiment of the present invention. As shown in FIG. 4, the apparatus 400 includes:

a receiving module 410, configured to receive a transaction request;

an account data read-write component 420, configured to: when a real-time account book is undergoing compute-intensive transaction processing, if an account record of an account on which a transaction is to be performed exists in a temporary account book, read the account record of the account on which the transaction is to be performed from the temporary account book, and if no account record of the account on which the transaction is to be performed exists in the temporary account book, read the account record of the account on which the transaction is to be performed from the real-time account book, and

when the real-time account book is not undergoing compute-intensive transaction processing, read the account record of the account on which the transaction is to be performed from the real-time account book;

a processor 430, configured to process the transaction request based on the account record of the account on which the transaction is to be performed read by the account data read-write component 420;

where the account data read-write component 420 is further configured to: when the real-time account book is undergoing compute-intensive transaction processing, if the account record of the account on which the transaction is to be performed exists in the temporary account book, update the account record of the account on which the transaction is to be performed and which is processed by the processor 430 to the temporary account book, if no account record of the account on which the transaction is to be performed exists in the temporary account book, record, in the temporary account book, the account record of the account on which the transaction is to be performed and which is processed by the processor 430, and

when the real-time account book is not undergoing compute-intensive transaction processing, update the account record of the account on which the transaction is to be performed and which is processed by the processor 430 to the real-time account book; and

an updating module 440, configured to update, after the compute-intensive transaction processing is complete, the real-time account book according to the temporary account book, and delete the account record from the temporary account book after the updating.

For example, during a non trial balance period, the account data read-write component reads the account record of the account on which the transaction is to be performed from the real-time account book, and updates, after the processor finishes processing, the processed account record to the real-time account book; during a trial balance period, the account data read-write component reads the account record of the account on which the transaction is to be performed from the temporary account book (if no account record of the account on which the transaction is to be performed exists in the temporary account book, reads the account record of the account on which the transaction is to be performed from the real-time account book), and updates, after the processor finishes processing, the processed account record to the temporary account book (if still no account record of the account on which the transaction is to be performed exists in the temporary account book, records the processed account record into the temporary account book).

In the embodiment of the present invention, optionally, the account data read-write component may be a DAO (Data Access Object) class, where the DAO class may, specific to different scenarios, choose to read an account record from the real-time account book or the temporary account book, and write the account record which is processed by the processor into the real-time account book or the temporary account book. The technical solution provided by the embodiment of the present invention can be implemented by merely modifying the DAO class, without the need to modify a service layer, which reduces an impact on architecture to a minimum extent.

The embodiment of the present invention does not affect service logic or a domain entity on a transaction layer, and just needs to modify a DAO entity on a data access layer, which facilitates extension of respective functions of transaction processing and day-end processing; meanwhile, no new field needs to be added to a database, and, because the real-time account book and the temporary account book are read and written separately, performance is not affected even if there are a large number of concurrent transactions.

In the embodiment of the present invention, optionally, the updating module 440 is specifically configured to read, when the temporary account book is not empty, a predetermined quantity of account records from the temporary account book, update, for each of the read account records, a corresponding account record in the real-time account book according to each of the account records, and delete each of the account records after the updating. It should be understood that, when the temporary account book is not empty, the updating module 440 repeats executing the foregoing operations.

The transaction processing apparatus 400 according to the embodiment of the present invention may correspond to an executing entity of the transaction processing method provided by the embodiments of the present invention, and the foregoing and other operations and/or functions of the modules in the apparatus 400 are respectively intended to implement corresponding procedures of the methods in FIG. 1 and FIG. 2, and, for brevity, details are not repeatedly described herein.

The transaction processing apparatus provided by the embodiment of the present invention processes, when a real-time account book is undergoing compute-intensive transaction processing, a transaction request based on a temporary account book, and updates, after the compute-intensive transaction processing is complete, the real-time account book according to the temporary account book, so as to implement a purpose of a real-time transaction when the real-time account book cannot be modified during a process of compute-intensive transaction processing like a trial balance process. In addition, because the account record that needs to be updated is only the account record of the transaction request received during the process of compute-intensive transaction processing and associated with the account record, compared with a method where all account records of a real-time account book need to be updated, the amount of calculation for the updating operation in the technical solution provided by the embodiment of the present invention is smaller.

It should be understood that, in the embodiments of the present invention, the term “and/or” describes only association relationships between associated objects, and indicates that three relationships may exist. For example, A and/or B may indicate that A exists alone, that both A and B exist, and that B exists alone. In addition, the symbol “/” in this specification generally indicates that the associated objects are in an “or” relationship.

A person of ordinary skill in the art may be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solution. A person skilled in the art may use a different method to implement the described functions for each particular application, but it should not be considered that such implementation goes beyond the scope of the present invention.

It can be clearly understood by a person skilled in the art that, for the purpose of convenient and brief description, for detailed working processes of the foregoing system, apparatus, and units, reference may be made to corresponding processes in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the division of units is merely a division of logical functions and there may be other divisions in actual implementation. For example, a plurality of units or components may be combined or integrated into another system, or some features may be ignored or not executed. In addition, the displayed or discussed mutual couplings or direct couplings or communication connections may be implemented through indirect couplings or communication connections between some interfaces, apparatuses or units, and may be implemented in electronic, mechanical, or other forms.

The units described as separate parts may be or not be physically separate, and parts displayed as units may be or not be physical units, and may be located in one position, or may be distributed on a plurality of network units. A part or all of the units may be selected according to actual needs to achieve the objectives of the solutions of the embodiments of the present invention.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in the form of a software product. The software product is stored in a storage medium and includes several instructions for instructing a computer device (which may be a personal computer, a server, or a network device) to perform all or a part of the steps of the methods described in the embodiments of the present invention. The foregoing storage medium includes: any medium that can store program code, such as a USB flash drive, a removable hard disk, a read-only memory (ROM, Read-Only Memory), a random access memory (RAM, Random Access Memory), a magnetic disk, or an optical disc.

The foregoing descriptions are merely specific embodiments of the present invention, but are not intended to limit the protection scope of the present invention. Any modification or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A transaction processing method, comprising:
receiving a transaction request;
determining, when it is determined that a real-time account book is undergoing compute-intensive transaction processing, whether an account record of an account on which a transaction is to be performed exists in a temporary account book;
if the account record of the account on which a transaction is to be performed exists in the temporary account book:
processing the transaction request based on the account record of the account on which the transaction is to be performed in the temporary account book, and
updating the account record of the account on which the transaction is to be performed in the temporary account book according to a processing result;
if no account record of the account on which a transaction is to be performed exists in the temporary account book:
reading the account record of the account on which the transaction is to be performed from the real-time account book,
processing the transaction request based on the account record of the account on which the transaction is to be performed, and
recording, in the temporary account book, the account record of the account on which the transaction is to be performed that is updated according to a processing result; and
updating, after the compute-intensive transaction processing is complete, the real-time account book according to the temporary account book, and deleting the account record from the temporary account book after the updating.

2. The method according to claim 1, further comprising:
processing, when it is determined that the real-time account book is not undergoing compute-intensive transaction processing, the transaction request based on the account record of the account on which the transaction is to be performed in the real-time account book: and
updating the account record of the account on which the transaction is to be performed in the real-time account book according to a processing result.

3. The method according to claim 1, wherein updating, after the compute-intensive transaction processing is complete, the real-time account book according to the temporary account book, and deleting the account record from the temporary account book after the updating comprises:
A1. when the temporary account book is not empty, reading a predetermined quantity of account records from the temporary account book;
A2. for each of the read account records, updating a corresponding account record in the real-time account book according to each of the account records, and deleting each of the account records after the updating; and
A3. after the predetermined quantity of the account records are updated, returning to step A1.

4. The method according to claim 2, wherein updating, after the compute-intensive transaction processing is complete, the real-time account book according to the temporary account book, and deleting the account record from the temporary account book after the updating comprises:
A1. when the temporary account book is not empty, reading a predetermined quantity of account records from the temporary account book;
A2. for each of the read account records, updating a corresponding account record in the real-time account book according to each of the account records, and deleting each of the account records after the updating; and
A3. after the predetermined quantity of the account records are updated, returning to step A1.

5. A transaction processing apparatus, comprising:
a transaction processing module, configured to:
receive a transaction request,
determine, when it is determined that a real-time account book is undergoing compute-intensive transaction processing, whether an account record of an account on which a transaction is to be performed exists in a temporary account book;
if the account record of the account on which a transaction is to be performed exists in the temporary account book:
process the transaction request based on the account record of the account on which the transaction is to be performed in the temporary account book, and
update the account record of the account on which the transaction is to be performed in the temporary account book according to a processing result, and
if no account record of the account on which a transaction is to be performed exists in the temporary account book:
read the account record of the account on which the transaction is to be performed from the real-time account book,
process the transaction request based on the account record of the account on which the transaction is to be performed, and
record, in the temporary account book, the account record of the account on which the transaction is to be performed that is updated according to a processing result; and
an updating module, configured to update, after the compute-intensive transaction processing is complete, the real-time account book according to the temporary account book, and delete the account record from the temporary account book after the updating.

6. The apparatus according to claim 5, wherein the transaction processing module is further configured to:
process, when it is determined that the real-time account book is not undergoing compute-intensive transaction processing, the transaction request based on the account record of the account on which the transaction is to be performed in the real-time account book; and
update the account record of the account on which the transaction is to be performed in the real-time account book according to a processing result.

7. The apparatus according to claim 5, wherein the updating module is configured to:
read, when the temporary account book is not empty, a predetermined quantity of account records from the temporary account book:
update, for each of the read account records, a corresponding account record in the real-time account book according to each of the account records; and
delete each of the account records after the updating.

8. The apparatus according to claim 6, wherein the updating module is configured to:
read, when the temporary account book is not empty, a predetermined quantity of account records from the temporary account book;
update, for each of the read account records, a corresponding account record in the real-time account book according to each of the account records; and
delete each of the account records after the updating.
